(19) United States
(12) Patent Application Publication
(10) Pub. No.: US 2024/0088928 A1
(43) Pub. Date: Mar. 14, 2024

(54) PRE-AMPLIFICATION OF DETECTOR FOR ULTRA-LOW-POWER WIRELESS COMMUNICATIONS

(71) Applicant: University of Notre Dame du Lac, South Bend, IN (US)

(72) Inventors: Jonathan Chisum, South Bend, IN (US); Nicolas Garcia, South Bend, IN (US); Nicholas Estes, South Bend, IN (US)

(21) Appl. No.: 18/467,212

(22) Filed: Sep. 14, 2023

Related U.S. Application Data
(60) Provisional application No. 63/375,553, filed on Sep. 14, 2022.

(51) Int. Cl. H04B 1/16; H01Q 23/00

(52) U.S. Cl. CPC H04B 1/16; H01Q 23/00

(57) ABSTRACT

A device includes a passive antenna configured to capture a signal beam. The example device includes a receiver configured to receive the signal from the antenna, amplify the received signal and output a binary response based on a comparison of the amplified signal to a threshold value. The antenna directs the signal beam to the receiver without consuming power.

### CROSS-REFERENCE TO RELATED APPLICATION

The present application is a non-provisional conversion of U.S. Pat. App. No. 63/375,553 entitled “Passive Pre-Amplified Millimeter-Wave Detectors for Ultra-Low-Power Wireless Communications,” filed Sep. 14, 2022, the contents of which are incorporated herein in their entirety and for any purpose.

### STATEMENT REGARDING FEDERALLY SPONSORED RESEARCH OR DEVELOPMENT

This invention was made with government support under grant N00014-20-C-1067 awarded by the Office of Naval Research (ONR). The government has certain rights in the invention.

### TECHNICAL FIELD

The present description relates generally to producing high-frequency spin-waves with ultra-small wavelengths based on interfacing large waveguides to magnetic thin films and more particularly to a short-wavelength spin wave transducer.

### BACKGROUND

Size limitations on circuitry, or how small circuits can be produced, are primarily based on higher densities of transistors. Transistors are miniature semiconductors that regulate and control the flow of voltage and current in electrical signals. As circuitry becomes increasingly miniaturized, manufacturers are placing the same number of transistors in smaller areas, accelerating loss of energy due to heat generation.

### SUMMARY

In some aspects, the techniques described herein relate to a system including: a passive antenna configured to capture a signal beam; and a receiver configured to: receive the signal from the antenna; amplify the received signal; and output a binary response based on a comparison of the amplified signal to a threshold value, wherein the antenna directs the signal beam to the receiver without consuming power.

In some aspects, the techniques described herein relate to a method including: providing a signal receiver, the signal receiver including: a detector configured to receive, as input, a signal and to provide, as output, an envelope based on the signal; an amplifier configured to amplify the envelope; and a comparator configured to generate a binary output based on a comparison of the amplified envelope to a threshold value; and positioning a passive antenna in front of the signal receiver, the passive antenna configured to capture the signal and to direct the signal to the signal receiver without consuming power.passive pre-amplified wave detectors for ultra-low-power wireless communications

### BRIEF DESCRIPTION OF THE DRAWINGS

FIG. 1 is a view of an example device for detecting signal waves with ultra-low-power consumption in accordance with the various examples disclosed herein.

### DETAILED DESCRIPTION

As carrier frequencies continue to rise and free space path loss requires higher antenna directivity, receiver topologies employing multiple active antennas (e.g., phased arrays) are becoming ubiquitous. These receivers not only require distribution of a local oscillator (LO) across the array for demodulation of dense quadrature modulation constellations and but also require the use of high-dynamic range analog chains and high-resolution analog-to-digital converters (ADCs). Both of these requirements raise power consumption and thermal dissipation challenges that have not yet been fully addressed.

An alternative approach to address the rise of carrier frequencies is to embrace non-linear systems and simple modulation schemes, reducing per-antenna spectral efficiency and sensitivity but achieving significantly better energy efficiency. One such system would utilize a diode-based millimeter-wave detector as an ultra-low-power receiver for on-off-keying (OOK) millimeter-wave waveforms, which are relevant to 5G and 6G, (and beyond) systems. However, the conversion efficiency of such a detector is proportional to the received power, which itself decreases over distance. As such, a power decrease of 1/R² (where R indicates a distance) is similarly applied for conversion efficiency, which results in an overall reduction of 1/R⁴ in detected signal strength. Accordingly, long-range communication is not possible with current configurations.

One attempt to address this extreme loss of power is to pre-amplify the diode detector with a millimeter-wave amplifier. However, the energy costs associated with operating such an amplifier almost entirely offset the energy savings from using the ultra-low-power receiver.

In light of these deficiencies, the present disclosure describes a system that positions a passive antenna in front of the diode detector or other non-linear receiver. This passive antenna provides significant gain without requiring additional power and preserves the initial energy savings.

The following disclosure of example methods and apparatus is not intended to limit the scope of the description to the precise form or forms detailed herein. Instead, the following disclosure is intended to be illustrative so that others may follow its teachings.

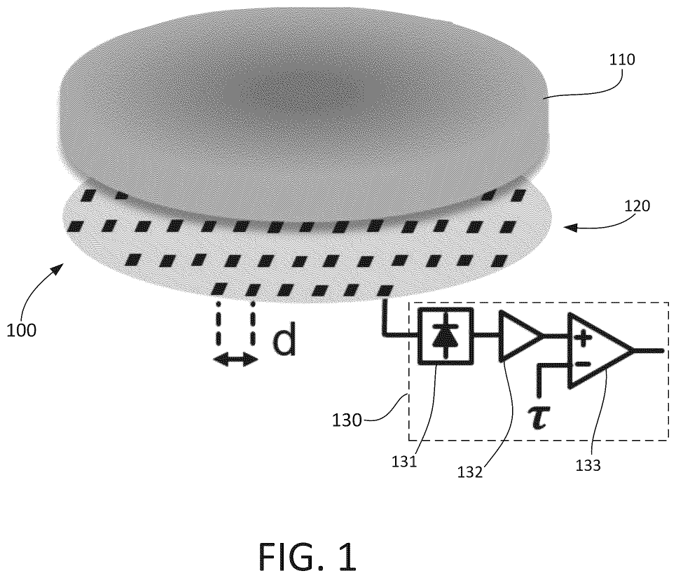

FIG. 1 is a diagram of an example system 100 for providing a low-power, low-cost receiver for transmitted signals. As shown, the system 100 includes an antenna 110 and an array 120. The antenna 110 may be any suitable antenna for steering a received signal beam, but is in one example, a flat gradient index (GRIN) lens due to its passive (and therefore energy-efficient) refraction. A size of the antenna 110 (e.g., lens) is based on a desired wavelength-sensitivity, with lower frequencies (e.g., larger wavelengths) requiring larger antennae or lenses. The array 120 is shown to include a plurality of receivers 130, such that the array 120 may proxy as a receiver array across an entire focal plane of the antenna 110. Although the exact value depends on the specific nature of each component in the system 100, the system 100 is capable of boosting a received signal by greater than 20 dB.

As shown, each receiver 130 is spaced d from an adjacent receiver 130, with the distance d based on the refraction (or beam-steering) capability of the antenna 110, such that each receiver 130 corresponds to an angle of signal beam steered by the antenna 110. In this way, the system 100 is designed such that any signal beam captured by the antenna 110 is directed to a receiver 130. This addresses the uni-directional nature (e.g., angular sensitivity) of each receiver 130, as a receiver 130 may otherwise be restricted to detecting signals having a particular beam angle.

The receiver 130 is shown to include a detector 131, an amplifier 132, and a comparator 133. The detector 131 may be an envelope detector, such as a diode, that is suitable for OOK modulation. The detector 131 may receive, as input, the signal that has been amplified by antenna 125 and provide, as output, an envelope (e.g., an outline of the sinusoidal signal). Particularly for OOK applications and for those at especially long ranges, the detector 131 may be a square-law diode detector that provides an output envelope directly proportional to a provided power, which may further boost the received signal at lower frequencies. The amplifier 132 may be a baseband amplifier configured to buffer the signal, and may receive, as input, the envelope from the detector 131 and provide, as output, an amplified envelope signal. The comparator 133 receives, as input, this amplified envelope signal and provides, as output, a binary indication of whether the amplified envelope signal is greater than a pre-defined threshold—shown in FIG. 1 as T (lowercase tau). In some examples, a radio-frequency low-noise amplifier (RFNLA) may also be utilized in order to improve system 100 sensitivity, due to the inherent noise figure of the detector 131.

Although reference is made throughout to the receiver 130 utilizing a diode for detector 131, this disclosure should not be read as limited to the use of diodes and should be read as extending to any suitable non-linear detector. In addition, the system 100 described herein may also be used with a linear detector, although the energy savings may not be as large given the significantly higher power cost of linear detectors.

The system as described herein has many possible uses. In a first use case, the system 100 may be included as part of a fixed wireless access (FWA) setup in which the signal generator and the receiver (e.g., the system 100) are both in fixed positions—or are at least fixed relative to each other. This particular use case renders the angular-sensitivity of the system 100 moot, as the relatively-fixed positions of the generator and receiver mean that there is no need for the system 100 to anticipate signals from multiple angles. These setups may be found for backhaul links and sight-to-sight links.

In a second use case, the system 100 may be included as part of a sensor array for detecting incoming objects (e.g., projectiles). In this use case, the system 100 may be supplemented by a signal generator, with the system 100 detecting when the generated signal bounces back to the system 100 from an object. Because the angle of the received signal is important in such a use case, multiple systems 100 may be arranged as an array, with each system 100 having its antenna 110 positioned at different angles. Due to the power-savings of the system 100, many multiples of systems 100 can be utilized while still remaining below the power consumption of current detectors.

In a third use case, the system 100 may be included as part of a mobile device network, with the system 100 receiving signals from said mobile device. Similar to the second use case, a plurality of systems 100 may be arranged as an array in order to be positioned to receive signals from the mobile device regardless of the mobile device's position. Alternatively, the system 100 may include a switch configured to move or re-position the antenna at regular intervals, which may serve as an array proxy.

While this disclosure has described certain examples, it will be understood that the claims are not intended to be limited to these examples except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed examples. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

What is claimed is:

1. A system comprising:
a passive antenna configured to capture a signal beam; and
a receiver configured to:
receive the signal from the antenna;
amplify the received signal; and
output a binary response based on a comparison of the amplified signal to a threshold value,
wherein the antenna directs the signal beam to the receiver without consuming power.

2. The system of claim 1, wherein the receiver comprises a plurality of receivers arranged in an array.

3. The system of claim 2, wherein a position of each of the plurality of receivers is based on the passive antenna, such that the position each of the plurality of receivers corresponds to a different angle of the signal beam captured by the passive antenna.

4. The system of claim 1, wherein the receiver further comprises a non-linear detector.

5. The system of claim 4, wherein the non-linear detector comprises a diode.

6. The system of claim 1, wherein a gain provided by the receiver for the received signal is greater than 24 dB.

7. The system of claim 1, wherein the passive antenna comprises a flat gradient index (GRIN) lens.

8. The system of claim 1, wherein the receiver further comprises a radio-frequency low-noise amplifier (RFNLA).

9. A method comprising:
providing a signal receiver, the signal receiver comprising:
a detector configured to receive, as input, a signal and to provide, as output, an envelope based on the signal;
an amplifier configured to amplify the envelope; and
a comparator configured to generate a binary output based on a comparison of the amplified envelope to a threshold value; and
positioning a passive antenna in front of the signal receiver, the passive antenna configured to capture the signal and to direct the signal to the signal receiver without consuming power.

10. The method of claim 9, wherein:
the signal receiver comprises a plurality of signal receivers each having the detector, the amplifier, and the comparator, and
the method further comprises positioning the plurality of signal receivers in an array based on a beam-steering property of the passive antenna.

11. The method of claim 9, wherein the detector comprises a diode.

12. The method of claim 9, wherein a gain provided by the receiver for the received signal is greater than 24 dB.

13. The method of claim 9, wherein the passive antenna comprises a flat gradient index (GRIN) lens.

14. The method of claim 9, wherein the receiver further comprises a radio-frequency low-noise amplifier (RFNLA).
